(19) United States
(12) Patent Application Publication
(10) Pub. No.: US 2009/0125610 A1
(43) Pub. Date: May 14, 2009

(54) Record transmission method for affiliate programs

(76) Inventors: Gregory A. Piccionelli, Westlake Village, CA (US); Michael M. Gerardi, Menifee, CA (US)

Correspondence Address: Michael M. Gerardi, Suite 200, 2801 Townsgate Road, Westlake Village, CA, 91361, US

(21) Appl. No.: 12/287,503

(22) Filed: Oct. 9, 2008

Related U.S. Application Data
(60) Provisional application No. 60/998,471, filed on Oct. 11, 2007.

(51) Int. Cl. G06F 15/16

(52) U.S. Cl. 709/219

(57) ABSTRACT

A method of obtaining and displaying content on a site on a network is provided. The content is provided by a content supplier to a content requester for display by the requester on the site on the network, and is subject to a regulation. According to the method, a request for at least one data file including content subject to a regulation is created by the content requester. The request is transmitted to the content provider, and a compilation file including copies of each requested data file is created by the content supplier. A record file including information pertaining to each requested data file, the information being required for compliance with the regulation, and information pertaining to the compilation file, the information being required for compliance with the regulation, is then created by the content supplier, and the compilation file and the record file are transmitted to the content requester. Finally, at least a portion of the requested data files including content subject to the regulation is displayed on a site on a network maintained by the content requester.

This application is based on U.S. Provisional Patent Application Ser. No. 60/998,471, filed Oct. 11, 2007 (attorney docket no. 39003.835USP1), the entire disclosure of which is incorporated herein by reference.

### FIELD OF THE INVENTION

The present invention relates to methods for transmitting information associated with content that may be subject to a regulation, in particular content provided by a content supplier to a content requester pursuant to an affiliate program.

### BACKGROUND OF THE INVENTION

The production of certain types of content is subject to various regulations. For example, 18 U.S.C. §2257, together with related federal regulations set out at 28 C.F.R. §75 eq seq., applies to the production of depictions of explicit sexual activity, and requires that content producers maintain records containing specified information pertaining to the production. The statute further requires placement of a statement, describing where the required records may be located, in specified locations with respect to the content.

While compliance with regulations such as 18 U.S.C. §2257 is relatively simple for producers of content, difficulties ensue when the content is distributed to other parties who intend to display the content, in particular those parties who intend to display the content on a site on a network such as the Internet. Such parties are frequently part of relationships called affiliate programs, in which members, called affiliates, receive content from a content supplier for posting on web sites maintained by the affiliates, in order to promote a website maintained by the content supplier. When content subject to a regulation is provided to the affiliate, it may be considered a copy of the content that is subject to the regulation in its own right. Furthermore, every page of a website, such as a website maintained by an affiliate pursuant to an affiliate program, that contains such content may be considered a copy of the content that is subject to the regulation. Thus, the affiliate may be required to maintain records and post compliance statements in accordance with the regulation.

A need exists for methods that facilitate compliance with pertinent regulations when content subject to such regulations is provided, via transmission over a network such as the Internet or by other means, from a content supplier to a content requester. In particular, a need exists for methods that facilitate compliance both by the content supplier and the content requester.

### SUMMARY OF THE PREFERRED EMBODIMENTS

In accordance with one aspect of the present invention, there is provided a method of obtaining and displaying content on a site on a network, the content being provided by a content supplier to a content requester for display by the requester on the site on the network, the content being subject to a regulation. The method includes the steps of: creating a request for at least one data file comprising content subject to a regulation, the request being created by the content requester; transmitting the request to the content provider; creating a compilation file comprising copies of each requested data file, the compilation file being created by the content supplier; creating a record file including i) information pertaining to each requested data file, the information being required for compliance with the regulation, and ii) information pertaining to the compilation file, the information being required for compliance with the regulation, the record file being created by the content supplier; transmitting the compilation file and the record file to the content requester; and displaying at least a portion of the requested data files including content subject to the regulation on a site on a network maintained by the content requester.

In a specific embodiment, the content requester is a member of an affiliate program maintained by the content supplier.

In another specific embodiment, the at least one data file is selected from a menu, more specifically a menu that is displayed on a site maintained by the content provider.

The request is transmitted, in particular embodiments, over a network. In further particular embodiments, information pertaining to the compilation file is also displayed within the compilation file according to the regulation. The content supplier also maintains records according to the regulation, and also updates the records to reflect creation of the compilation file, in still further particular embodiments.

The compilation file and the record file are transmitted over a network in certain embodiments. In certain additional embodiments, the compilation file and the record file are combined to form a single file.

In specific embodiments, the content requester displays the information pertaining to each requested data file in a manner required by the regulation. The content requester displays information on each page displayed on the website maintained by the content requester, the information pertaining to each requested data file displayed on such page, in more specific embodiments. In other more specific embodiments, the content requester also maintains records pertaining to each requested data file, the records including the information pertaining to each requested data file as provided in the record file, in a manner required by the regulation.

Between creation of the record file and transmission of the compilation file and the record file, the content requester, in particular embodiments, executes an agreement to use the requested content in compliance with the regulation.

According to another aspect of the present invention, there is provided a method of providing content subject to a regulation to a user requesting the content. The method includes the steps of: receiving a request from the user for at least one data file including content subject to a regulation; creating a compilation file including copies of each requested data file; creating a record file including information pertaining to each requested data file, the information being required for compliance with the regulation and information pertaining to the compilation file, the information being required for compliance with the regulation; and transmitting the compilation file and the record file to the user.

In particular embodiments, the regulation is a record-keeping regulation. In other particular embodiments, the information pertaining to the compilation file is displayed within the file in accordance with the regulation.

In accordance with still another aspect of the present invention, there is provided a method of obtaining and displaying content on a site on a network, the content being provided by a content supplier to a member of an affiliate program maintained by the content supplier for display by the member on the site on the network, the content being subject to a record-keeping regulation. The method includes the steps of: creating a request for at least one data file including content subject to a record-keeping regulation, the request being created by the member by selecting at least one data file from a menu displayed on a site maintained by the content provider; transmitting the request to the content provider over a network; creating a compilation file including copies of each requested data file, the compilation file being created by the content supplier; updating records associated with each requested data file as required by the record-keeping regulation to reflect creation of the compilation file, the updating being performed by the content supplier; creating a first record file including information pertaining to each requested data file, the information being required for compliance with the record-keeping regulation and information pertaining to the compilation file, the information being required for compliance with the record-keeping regulation, the first record file being created by the content supplier; creating a second record file including information pertaining to the compilation file, the information being required for compliance with the record-keeping regulation; transmitting the compilation file and the first record file to the member over a network; and displaying at least a portion of the requested data files comprising content subject to the record-keeping regulation on a site on a network maintained by the member, wherein the member further displays information on each page on the site pertaining to each requested data file displayed on such page in accordance with the record-keeping regulation.

In specific embodiments, when the first record file is created, information pertaining to the compilation file is also displayed within the compilation file according to the record-keeping regulation. In other specific embodiments, after the second record file is created and before the compilation file and the first record file are transmitted, the member executes an agreement to use the requested content in compliance with the regulation.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flow chart illustrating a method of obtaining and displaying content on a site on a network according to the present invention, and

FIG. 2 is a flow chart illustrating a more particular method according to the invention wherein content is provided and displayed in the context of an affiliate program.

### DETAILED DESCRIPTION OF THE PREFERRED EMBODIMENTS

Methods according to the present invention enable a content requester, such as an affiliate webmaster, to select one or more data files containing content subject to a regulation, for example a statute such 18 U.S.C. §2257 and its associated federal regulations as set forth at 28 C.F.R. §75 et seq., and to receive as an assembled, complete work the requested content, together with information pertaining to the content as required by the regulation and displayed in accordance with the regulation. Methods according to the invention also facilitate compliance with such a regulation by the content supplier, in particular by creating a single, complete work to which the content supplier can easily attach additional information, for example statements such as compliance statements, as may be required by the regulation.

In typical embodiments of the inventive method, a content requester, such as a webmaster, accesses a website or other location maintained by a content supplier and selects one or more data files containing desired content, such as banners, advertisements, text, and photographic or video content, at least one such data file including content subject to a regulation. The content requester transmits a request to the content supplier, who then prepares a compilation file containing the requested data files, together with a record file that includes content information in accordance with the regulation. The content supplier then transmits the compilation file and the record file to the content requester. Once the files have been transmitted, the content requester now has the information necessary to comply with the regulation.

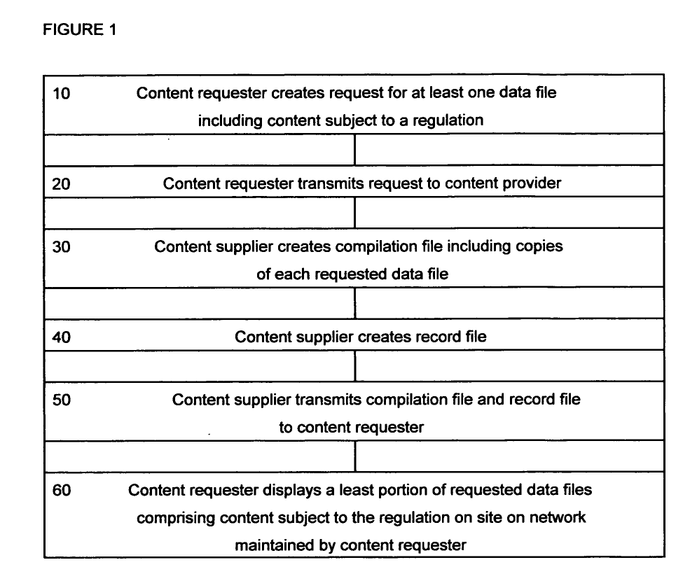

Turning now to FIG. 1, in step 10 a content requester creates a request for at least one data file that includes content subject to a regulation. The content requester can be, in particular embodiments, a member of an affiliate program maintained by the content producer. Alternatively, the content requester can be a non-affiliate user. Such non-affiliate users can pay a premium to access and request provision of the content, in more specific embodiments.

The data file can be selected, for example, from a menu, such as a menu displayed on a site on a network such as the Internet. The selection can be implemented using conventional applications, such as shopping carts, as is known to those skilled in the art. In other embodiments, the data file can be selected from a printed listing or a listing provided in any other desired medium.

In step 20, once the request has been prepared, the content requester transmits the request to the content supplier. The request can be transmitted to the content supplier over a network such as the Internet. Any other mode of transmission, such as via telephone, mail, courier, personal delivery, etc., can also be employed if desired.

Having received the request transmission, the content supplier creates a compilation file including copies of each requested data file (step 30). The compilation file thus constitutes a complete work in its own right. Next, the content supplier creates a record file for the compilation file. The record file includes information pertaining to each requested data file subject to the regulation. For example, the regulation may require the names, ages, stage names and other information associated with each performer depicted in the content included in the requested data file; this information would be included in the record file. The record file also includes, in particular embodiments, information pertaining to the compilation file itself that may be required by the pertinent regulation. For example, the regulation may require a date of production for the compilation file; the date on which the compilation file was created by the content supplier would be included in the record file, or, alternatively, in a separate file if compliance with the regulation so requires.

After creation of the compilation file and the record file, both files are transmitted to the content requester (step 50). Transmission can take place over the same network used to transmit the request, or by any other means of communication desired. Alternatively, the compilation file and the record file can be combined into a single file and then transmitted to the content requester.

In some embodiments, the content provider transmits an acknowledgment to the content requester, listing the data files requested, prior to transmission of the compilation and record files. An exemplary acknowledgment might include a message reading, “You have selected the following for your affiliate marketing program”, followed by a listing of the requested data files. In more particular embodiments, a compliance statement or other information as required by the regulation can be included with the acknowledgment and the listing of data files. Thus, in embodiments in which data files comprising content subject to 18 U.S.C. §2257 are assembled into a compilation file, a statement indicating where required records are kept may be included in the acknowledgment.

In further specific embodiments, the content supplier can provide to the content requester an agreement stating that the content requester will comply with the regulation in any and all subsequent uses of the requested content. For example, the agreement might state: “You hereby agree that all of your use of the requested materials will comply with 18 U.S.C. §2257. The required records pertaining to the requested materials are being transmitted to you in the attached file labeled 2257 RECORDS.” The content requester's agreement is required prior to transmission of the compilation file and the record file to the content requester.

In more particular embodiments, the content supplier provides an appropriate label to the compilation file, prepares appropriate records for the compilation file in accordance with the regulation, and otherwise complies with the regulation as applied to the compilation file. Such compliance may require, for example, updating of additional records pertaining to one or more performer depicted in the content.

Once the content requester has received the compilation file and the record file, the content requester is enabled to comply with the regulation and to display some or all of the requested content, typically on a site on a network maintained by the content requester. The compilation file can, for example, be displayed as a single page on the site; the record file thus contains records sufficient to enable compliance with the regulation with respect to the single page so displayed. Should the content requester subsequently disassemble the compilation file in order to display one or more of its component data files on separate pages on the site, information can be extracted from the record file and used to ensure that each such separate page complies with the regulation.

Methods according to the present invention thus enable compliance by both the content requester and the content supplier. The content requester receives sufficient information to prepare records required by pertinent regulations, and to display the requested content, in combination or separately, in a manner that complies with the regulations. The content supplier, producing a single, unified work, is enabled to comply with the regulations in a simple manner, without the burden of having to perform multiple compliance operations for each of the component data files of the compilation file.

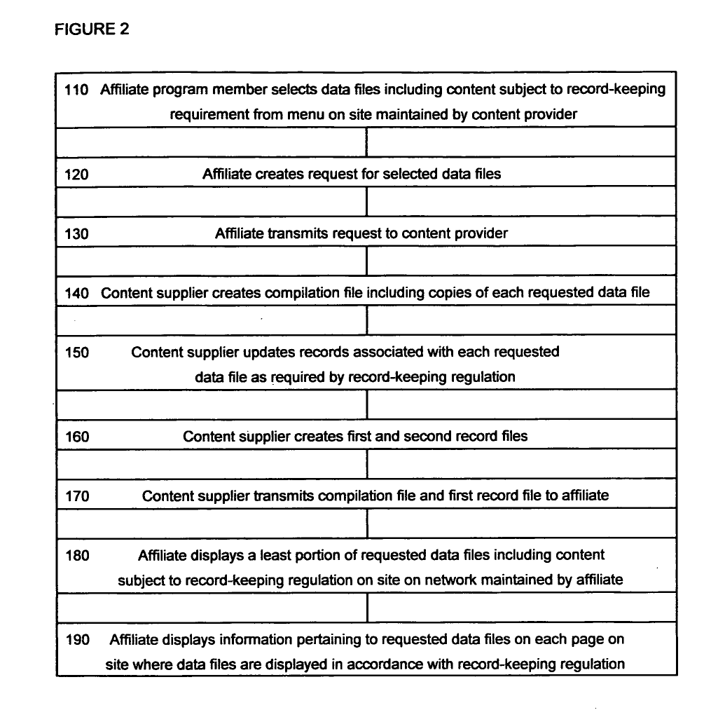

In FIG. 2, an affiliate program member (hereinafter “affiliate”) selects at least one data file that includes content subject to a record-keeping requirement, such as 28 C.F.R. 75 et seq., from a menu on a site maintained by a content provider (step 110). The affiliate creates a request for the selected data files (step 120), and in step 130 transmits the request to the content supplier.

Once the content supplier receives the request from the affiliate, it creates a compilation file including copies of each requested data file (step 140). When creating the compilation file, the content supplier typically must update its own records for each of the requested data files to indicate that the files were used in the compilation file. For example, the content supplier, pursuant to 28 C.F.R. 75 et seq., can be required to update its records to indicate that various performers appearing in the requested data files now also appear in the newly-created compilation file. Thus (step 150), the content supplier updates its own records associated with each requested data file as required by the record-keeping regulation.

Next, the content supplier creates first and second record files (step 160). The first record file includes information pertaining to each requested data file, and information pertaining to the compilation file, as required for compliance with the record-keeping regulation. The second record file includes information pertaining to the compilation file, as the compilation file itself typically becomes independently subject to the record-keeping regulation, e.g., 28 C.F.R. 75 et seq. The content supplier transmits the compilation file and the first record file to the affiliate (step 170), while it maintains the second file for its own records.

After receiving the compilation file and the first record file, the affiliate (step 180) displays a least a portion of the requested data files, including content subject to the record-keeping regulation, on a site on a network maintained by the affiliate. Receipt of the first record file enables the affiliate to display information pertaining to the requested data files on each page on the site where the requested data files are displayed, in accordance with the record-keeping regulation (step 190).

What is claimed is:

1. A method of obtaining and displaying content on a site on a network, the content being provided by a content supplier to a content requester for display by the requester on the site on the network, the content being subject to a regulation, the method comprising the steps of:
a) creating a request for at least one data file comprising content subject to a regulation, the request being created by the content requester,
b) transmitting the request to the content provider,
c) creating a compilation file comprising copies of each requested data file, the compilation file being created by the content supplier,
d) creating a record file comprising
i) information pertaining to each requested data file, the information being required for compliance with the regulation, and
ii) information pertaining to the compilation file, the information being required for compliance with the regulation,
the record file being created by the content supplier,
e) transmitting the compilation file and the record file to the content requester, and
f) displaying at least a portion of the requested data files comprising content subject to the regulation on a site on a network maintained by the content requester.

2. The method of claim 1 wherein the content requester a member of an affiliate program maintained by the content supplier.

3. The method of claim 1 wherein the at least one data file is selected from a menu.

4. The method of claim 3 wherein the menu is displayed on a site maintained by the content provider.

5. The method of claim 1 wherein in step b) the request is transmitted over a network.

6. The method of claim 1 wherein in step d) information pertaining to the compilation file is also displayed within the compilation file according to the regulation.

7. The method of claim 1 wherein the content supplier also maintains records according to the regulation and wherein in step d) the content supplier also updates the records to reflect creation of the compilation file.

8. The method of claim 1 wherein in step e) the compilation file and the record file are transmitted over a network.

9. The method of claim 1 wherein the compilation file and the record file are combined to form a single file.

10. The method of claim 1 wherein in step f) the content requester displays the information pertaining to each requested data file in a manner required by the regulation.

11. The method of claim 10 wherein the content requester displays information on each page displayed on the website maintained by the content requester, the information pertaining to each requested data file displayed on such page.

12. The method of claim 10 wherein the content requester also maintains records pertaining to each requested data file, the records including the information pertaining to each requested data file as provided in the record file, in a manner required by the regulation.

13. The method of claim 1 wherein after step d) and prior to step e) the content requester executes an agreement to use the requested content in compliance with the regulation.

14. A method of providing content subject to a regulation to a user requesting the content, the method comprising the steps of:
a) receiving a request from the user for at least one data file comprising content subject to a regulation,
b) creating a compilation file comprising copies of each requested data file,
c) creating a record file comprising
i) information pertaining to each requested data file, the information being required for compliance with the regulation, and
ii) information pertaining to the compilation file, the information being required for compliance with the regulation, and
d) transmitting the compilation file and the record file to the user.

15. The method of claim 14 wherein the regulation is a record-keeping regulation.

16. The method of claim 14 wherein in step c) the information pertaining to the compilation file is displayed within the file in accordance with the regulation.

17. A method of obtaining and displaying content on a site on a network, the content being provided by a content supplier to a member of an affiliate program maintained by the content supplier for display by the member on the site on the network, the content being subject to a record-keeping regulation, the method comprising the steps of:
a) creating a request for at least one data file comprising content subject to a record-keeping regulation, the request being created by the member by selecting at least one data file from a menu displayed on a site maintained by the content provider,
b) transmitting the request to the content provider over a network,
c) creating a compilation file comprising copies of each requested data file, the compilation file being created by the content supplier,
d) updating records associated with each requested data file as required by the record-keeping regulation to reflect creation of the compilation file, the updating being performed by the content supplier,
e) creating a first record file comprising
i) information pertaining to each requested data file, the information being required for compliance with the record-keeping regulation, and
ii) information pertaining to the compilation file, the information being required for compliance with the record-keeping regulation,
the first record file being created by the content supplier,
f) creating a second record file comprising information pertaining to the compilation file, the information being required for compliance with the record-keeping regulation,
g) transmitting the compilation file and the first record file to the member over a network,
h) displaying at least a portion of the requested data files comprising content subject to the record-keeping regulation on a site on a network maintained by the member, wherein the member further displays information on each page on the site pertaining to each requested data file displayed on such page in accordance with the record-keeping regulation.

18. The method of claim 17 wherein in step e) information pertaining to the compilation file is also displayed within the compilation file according to the record-keeping regulation.

19. The method of claim 17 wherein after step f) and prior to step g) the member executes an agreement to use the requested content in compliance with the regulation.
